(19) United States
(12) Patent Application Publication
(10) Pub. No.: US 2011/0122104 A1
(43) Pub. Date: May 26, 2011

(54) LIQUID CRYSTAL DRIVING DEVICE AND LIQUID CRYSTAL DISPLAY DEVICE

(75) Inventor: Hirokata UEHARA, Kawasaki (JP)

(73) Assignee: FUJITSU LIMITED, Kawasaki (JP)

(21) Appl. No.: 12/951,398

(22) Filed: Nov. 22, 2010

(30) Foreign Application Priority Data
Nov. 26, 2009 (JP) 2009-269070

(51) Int. Cl. G06F 3/038

(52) U.S. Cl. 345/204; 345/98

(57) ABSTRACT

A liquid crystal driving device includes a plurality of scan electrodes; a signal electrode arranged along a direction that intersects with the plurality of scan electrodes and forms a pixel for each intersection with the plurality of scan electrodes; and a control circuit configured to set a drawing line that is made up of series of the pixels, and a plurality of pre-drive lines that are different from the drawing line along a direction in parallel with the scan electrode and supplies image data that corresponds to the drawing line from the signal electrode while shifting the drawing line and the plurality of pre-drive lines to a direction that intersects with the scan electrode. The control circuit discretely drives the plurality of pre-drive lines.

### CROSS-REFERENCE TO RELATED APPLICATIONS

This application is based upon and claims the benefit of priority of the prior Japanese Patent Application No. 2009-269070, filed on Nov. 26, 2009, the entire contents of which are incorporated herein by reference.

### FIELD

The present disclosure generally relates to a liquid crystal driving device and a liquid crystal display device.

### BACKGROUND

Recently, the development of electronic paper has been advancing. The electronic paper may use a display element that utilizes a cholesteric liquid crystal. Cholesteric liquid crystals have excellent characteristics such as a semi-permanent display maintaining function, a bright color display, a high contrast ratio, and a high resolution.

A display element that uses a cholesteric liquid crystal may exhibit a planar state that reflects light with a specific wavelength, a focal conic state that transmits light, and an intermediate state between the above-described two states by adjusting electric field intensity to be applied.

When strong electric field is applied to a cholesteric liquid crystal, a homeotropic state is obtained in which the liquid crystal molecules follow the direction of the electric field. Then, when the electric field in the liquid crystal is rapidly reduced to substantially zero, the helical axis of the liquid crystal becomes substantially vertical to the electrodes. In other words, the liquid crystal is brought into the planar state where light corresponding to the helical pitch is selectively reflected. When a relatively weak electric field that does not disentangle the helical structure of the liquid crystal is applied to the cholesteric liquid crystal, and the electric field is removed, or a strong electric field is applied to the cholesteric liquid crystal and the electric field is slowly removed, the helical axis of the liquid crystal molecules becomes parallel to the electrodes. The liquid crystal is brought into the focal conic state where incident light is transmitted. When an electric field of intermediate strength is applied and the electric field is rapidly removed, the planar state and the focal conic state coexist. Thus, the liquid crystal may display intermediate tones. Information is displayed by utilizing this phenomenon.

FIGS. 12A to 12C illustrate an operation example of a liquid crystal driving device. A common driver 31 and a segment driver 32 are coupled to a display element 30. Selected line data is supplied to the common driver 31. Image data for each line is supplied to the segment driver 32. The segment driver 32 outputs on/off voltages in response to image data to the display element 30. The common driver 31 applies a voltage to pixels in the selected line. Through the above-described processing, the display element 30 displays an image. The selected line is a group of pixels over a scan electrode selected by the common driver 31 and is in parallel with a scan electrode that is arranged from the common driver 31 to the display element 30.

For example, as illustrated in FIG. 12A, when the common driver 31 selects the first line of the display element 30, the segment driver 32 outputs image data for the first line to the display element 30. The first line of the display element 30 performs a display that corresponds to the image data.

Likewise, as illustrated in FIG. 12B, when the common driver 31 selects the second line of the display element 30, the segment driver 32 outputs image data for the second line to the display element 30. The second line of the display element 30 performs a display that corresponds to the image data. Similarly, substantially the same operation as those described for and illustrated in FIGS. 12A and 12B applies to the third line of the display element 30 as illustrated in FIG. 12C.

In the above-described matrix driving, a display is performed for each line. Thus, for example, the number of selected lines becomes large in a display element for a large screen; thus, the display processing takes a long time.

Accordingly, a display device driving method is proposed in which a reset period is provided prior to a rewrite period; and in a reset period, a voltage is collectively applied to a few to several tens of lines in band-shape (see, for example, International Publication Pamphlet No. 2005-024774).

However, in the display element driving method discussed in the International Publication Pamphlet No. 2005-024774, a phenomenon may be caused in which a white display is not sufficiently white or a black display is not sufficiently black (hereinafter, indicated as a black float).

In other words, in the above-described display device driving method, because a voltage is collectively applied to a few to several tens of lines in band-shape, pixels of black dots may appear after typically white dots continue. When typically white dots continue, the liquid crystal state of the pixels is maintained to be a homeotropic state until the arrival of a rewrite period. Accordingly, even if a black dot drawing voltage (a transition voltage to a focal conic state) is applied when rewriting to black, insufficient black is displayed. In other words, a black float is generated.

Meanwhile, when a certain number of black dots continue, and subsequent dot is a black dot drawing voltage, a focal conic state with sufficient saturation is obtained, and black with high concentration is displayed. Thus, a black float appears at a black display immediately after the white display continues.

For example, an example in FIG. 13 illustrates a black float. Pixels included in a previously scanned line are assumed to continuously display white. Pixels in a certain interval from a pixel where display is switched from white to black may not reproduce black to be originally displayed. In other words, as illustrated in FIG. 13, pixels in the certain interval (area) are in a state of a black float in which black is not sufficiently displayed.

### SUMMARY

According to an aspect of the invention, a liquid crystal driving device includes a plurality of scan electrodes; a signal electrode arranged along a direction that intersects with the plurality of scan electrodes and forms a pixel for each intersection with the plurality of scan electrodes; and a control circuit configured to set a drawing line that is made up of a series of the pixels, and a plurality of pre-drive lines that are different from the drawing line along a direction in parallel with the scan electrode and supplies image data that corresponds to the drawing line from the signal electrode while shifting the drawing line and the plurality of pre-drive lines to a direction that intersects with the scan electrode, wherein the control circuit discretely drives the plurality of pre-drive lines.

According to another aspect of the present invention, a liquid crystal display device includes a plurality of scan electrodes; a signal electrode arranged along a direction that intersects with the plurality of scan electrodes and forms a pixel for each intersection with the plurality of scan electrodes; and a control circuit configured to set a drawing line that is made up of a series of the pixels, and a plurality of pre-drive lines that are different from the drawing line along a direction in parallel with the scan electrode and supplies image data that corresponds to the drawing line from the signal electrode while shifting the drawing line and the plurality of pre-drive lines to a direction that intersects with the scan electrode, wherein the control circuit discretely drives the plurality of pre-drive lines.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a circuit configuration of a liquid crystal driving device according to an embodiment of the present invention;

FIG. 2 illustrates circuit configurations of a common driver and a segment driver;

FIGS. 3A and 3B illustrate response characteristics of cholesteric liquid crystals as a relationship between an applied voltage and a reflectance;

FIG. 4 illustrates a driving operation according to a first embodiment of the present invention;

FIG. 5 illustrates changes of voltages with time of a pre-drive line according to the first embodiment;

FIG. 6 illustrates states of liquid crystals at pre-drive;

FIG. 7 illustrates a result of a discrete pre-drive;

FIG. 8 illustrates a driving processing according to a second embodiment of the present invention;

FIG. 9 illustrates a transient planar state;

FIG. 10 illustrates brightness characteristics for voltage application time;

FIG. 11 is a conceptual diagram of a liquid crystal display device with an RGB laminated structure;

FIGS. 12A to 12C illustrate a driving example of a liquid crystal driving device; and

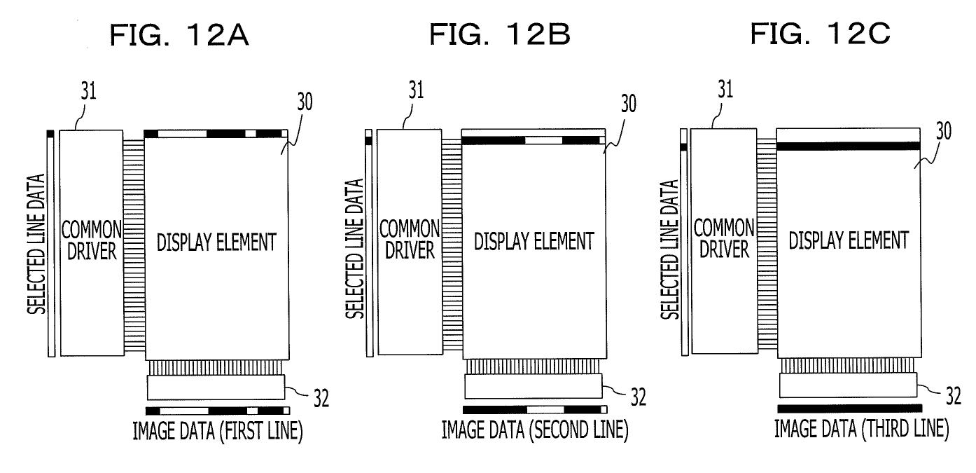

FIG. 13 illustrates an example of a black float.

### DESCRIPTION OF EMBODIMENTS

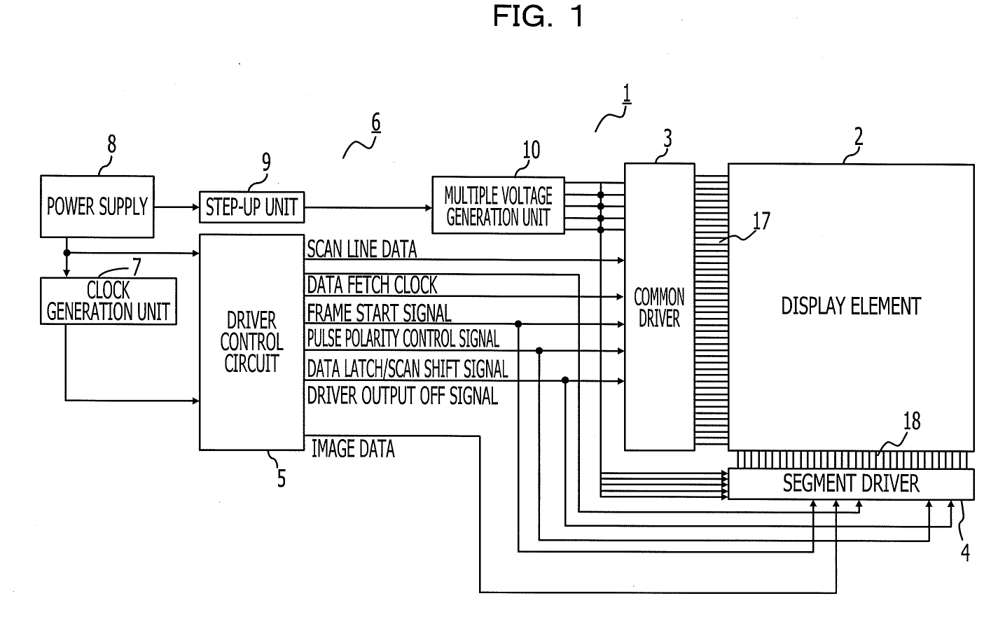

FIG. 1 illustrates a circuit configuration of a liquid crystal driving device according to a first embodiment of the present invention.

A liquid crystal driving device 1 includes a display element 2, a common driver 3, a segment driver 4, a driver control circuit 5, a power supply unit 6, and a clock generation unit 7. Many scan electrodes 17 are arranged from the common driver 3 to the display element 2. Many signal electrodes 18 are arranged from the segment driver 4 to the display element 2.

The scan electrodes 17 and the signal electrodes 18 are arranged in matrix; and pixels are formed in each intersection of the scan electrode 17 and the signal electrode 18. The scan electrode 17 and the signal electrode 18 dynamically drive the display element 2. The driver control circuit 5 supplies various control signals to the common driver 3 and the segment driver 4. The power supply unit 6 supplies power to the common driver 3 and the segment driver 4.

The power supply unit 6 includes a power supply 8, a step-up unit 9, and a multiple voltage generation unit 10. A voltage of 3V to 5V that is supplied to the power supply 8 is stepped up to, for example, 36V to 40V by the step-up unit 9. The step-up unit 9 includes a step-up regulator (such as, a DC-DC converter). The multiple voltage generation unit 10 generates a voltage, which will be described later, based on the voltage stepped up by the step-up unit 9. The multiple voltage generation unit 10 supplies voltages to the common driver 3 and the segment driver 4.

The clock generation unit 7 receives power supply from the power supply 8. The clock generation unit 7 oscillates a reference clock, divides the reference clock, and supplies the reference clock and the divided reference clock to the driver control circuit 5.

The driver control circuit 5 generates data and control signals that are supplied to the common driver 3 and the segment driver 4. For example, the driver control circuit 5 generates scan line data, a data fetch clock, a frame start signal, a pulse polarity control signal, a data latch/scan shift signal, and a driver output OFF signal as illustrated in FIG. 1. Image data is supplied from a host device, which is not illustrated, to the driver control circuit 5 and is output to the segment driver 4 at a timing, which will be described later.

The scan line is a group of lined pixels on the scan electrode 17 selected by the common driver 3; and a write line is a line among the scan lines to which image data is actually written. Accordingly, the scan line and the write line are in parallel with the above-described scan electrodes.

The frame start signal is output to the common driver 3. For example, the driver control circuit 5 instructs the display element 2 of 1024×768 pixels to start display processing. The scan line data is selection data for the write line, and is output to the common driver 3.

The data fetch clock is output to the segment driver 4 and image data is supplied from the driver control circuit 5 to the segment driver 4 substantially in synchronization with the signal. The image data is serially input to the segment driver 4, and is latched to a latch circuit (latch register), which will be described later, in the segment driver 4 substantially in synchronization with data latch/scan shift signal when image data for one line is input.

The pulse polarity control signal controls switching polarities of a voltage supplied from the common driver 3 and the segment driver 4 to the display element 2. The driver output OFF signal stops supplying power to the common driver 3 and the segment driver 4 after completing writing image data to the display element 2.

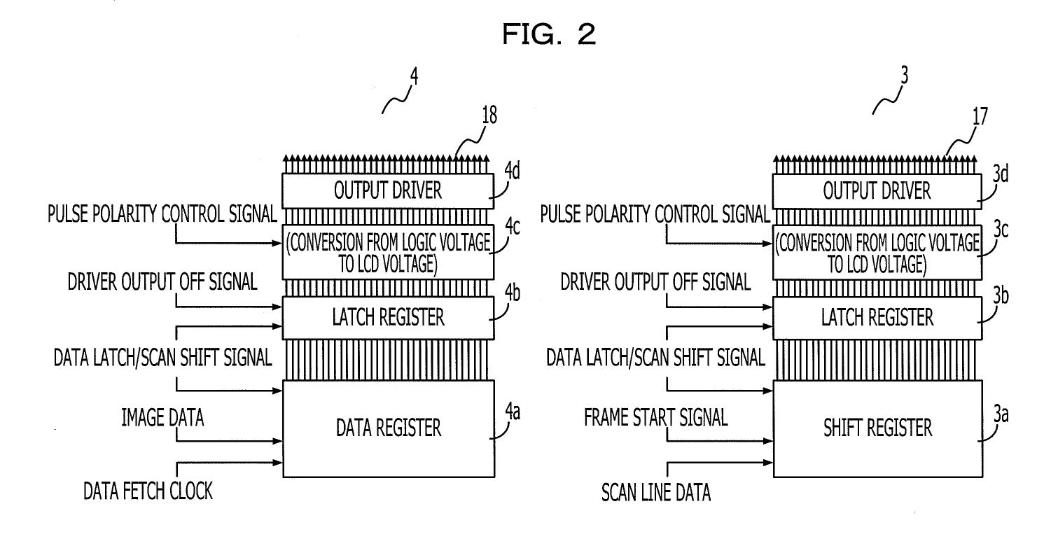

FIG. 2 illustrates circuit configurations of the common driver 3 and the segment driver 4. The common driver 3 includes a shift register 3a, a latch register 3b, a voltage conversion unit 3c, and an output driver 3d. The above-described data latch/scan shift signal, frame start signal, and scan line data are supplied to the shift register 3a. The scan line data supplied to the shift register 3a is latched by the latch register 3b substantially in synchronization with an output of the data latch/scan shift signal. Moreover, a logic voltage of the scan line data is converted into an LCD voltage (voltage for driving LCD), and is output to the display element 2 from the output driver 3d. Furthermore, the pulse polarity control signal controls a polarity of the pulse signal that is output from the output driver 3d.

The segment driver 4 includes a data register 4a, a latch register 4b, a voltage conversion unit 4c, and an output driver 4d. The above-described image data is supplied to the data register 4a substantially in synchronization with a data fetch clock signal. For example, image data for one line is retained in the data register 4a. The image data retained in the data register 4a is latched by the latch register 4b substantially in synchronization with a data latch/scan shift signal. A logic voltage of the image data is converted into an LCD voltage (voltage for driving LCD) by the voltage conversion unit 4c and is output to the display element 2 from the output driver 4d. Furthermore, the pulse polarity control signal controls a polarity of the pulse signal that is output from the output driver 4d.

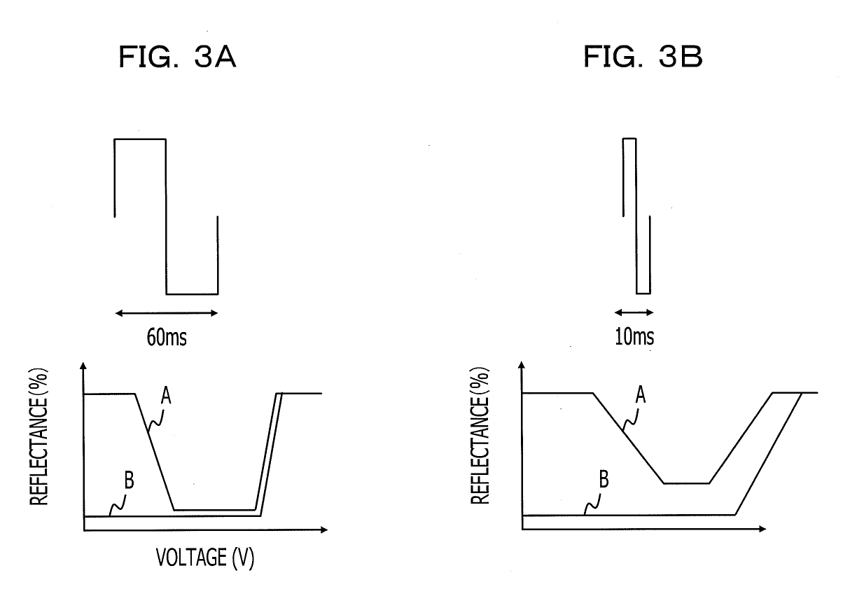

FIGS. 3A and 3B illustrate response characteristics of cholesteric liquid crystals as a relationship between an applied voltage and a reflectance. For example, as illustrated in FIG. 3A, when an initial state is a planar state (indicated by A in FIG. 3A), the cholesteric liquid crystal is brought into a driving range to the focal conic state if a pulse voltage with a long cycle (for example, 60 ms/line) is increased to a voltage of a certain range. When the voltage is increased, the cholesteric liquid crystal is brought into a driving range of the planar state. Moreover, if the initial state is the focal conic state (indicated by reference letter B in FIG. 3A), the cholesteric liquid crystal is gradually brought into the driving range of the planar state as the voltage is increased.

As illustrated in FIG. 3B, when a pulse having a cycle that is short (for example, 10 ms/line) is applied, the applied energy becomes small. Accordingly, even if substantially the same voltage as that applied to FIG. 3A, the time for applying voltage is shorter and a change amount of liquid crystal molecules becomes smaller. The voltage characteristics are shifted to a high voltage side. In FIG. 3B, an initial state of A is a planar state, while an initial state of B is a focal conic state.

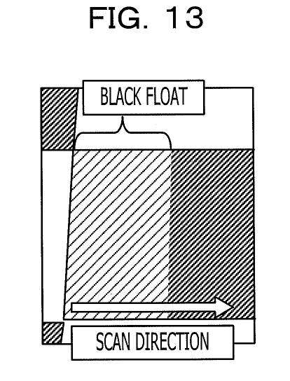

As illustrated in FIG. 13, a block float appears at a pixel of a black dot after typically white dots continue. In other words, when typically white dots continue, a homeotropic state of the pixel is maintained until the arrival of a rewrite period. Accordingly, insufficient black display is obtained even if a black dot drawing voltage (=transition voltage to a focal conic state) is applied when rewriting to black. In other words, a black float is caused.

Meanwhile, a sufficiently saturated focal conic state is obtained and a black display with high concentration is obtained when a black dot drawing voltage is applied to a dot after a certain number of black dots continue. As described above, a black float appears at a black display immediately after white displays continue.

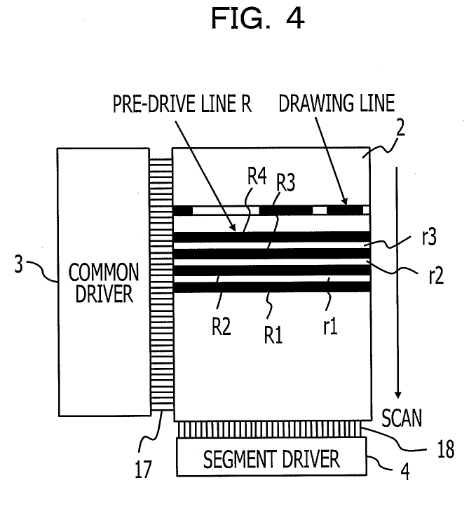

The display element 2 in FIG. 4 is configured as illustrated in FIG. 1 has, for example, 1024×768 pixels and a liquid crystal mixture is sealed between film substrates (electrodes). Moreover, the display element 2 is driven by applied voltages that are output from the common driver 3 and the segment driver 4.

As illustrated in FIG. 4, according to the embodiment, the pre-drive lines R1, R2, R3, and R4 are not continuous. In other words, a stop line r1 is sandwiched between the pre-drive lines R1 and R2; a stop line r2 is sandwiched between the pre-drive lines R2 and R3; and a stop line r3 is sandwiched between the pre-drive lines R3 and R4. The signal electrode 18 does not apply a high voltage to a line that is set to be a stop line.

Thus, according to the embodiment, a plurality of pre-drive lines is not continuous along a scan direction (“Scan” direction in FIG. 4); and a stop line is sandwiched between each of the pre-drive lines. A drawing line to which an image is drawn is shifted to the scan direction and pre-drive lines and a stop line are shifted to the scan direction.

Thus, even if a line becomes a pre-drive line and the liquid crystal is homeotropically aligned, an application of a high voltage to liquid crystal is interrupted because the line becomes a stop line. Hence, a homeotropic state does not continue in terms of time, and the above-described black float is reduced, if not prevented.

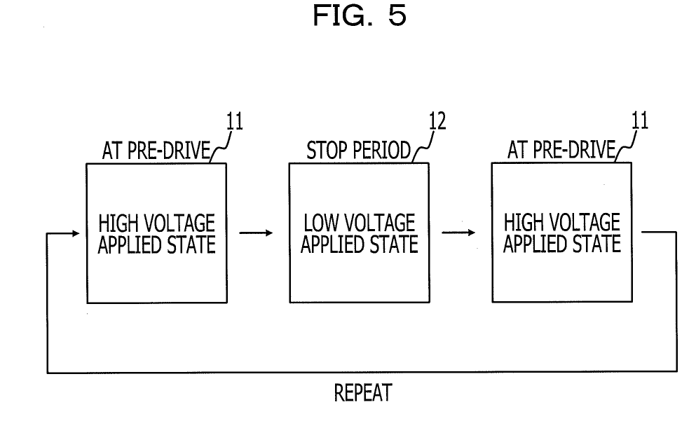

FIG. 5 illustrates changes of voltages with time of a pre-drive line R according to the embodiment. As illustrated in FIG. 5, in each of the pre-drive lines R, which are R1, R2, R3, and R4, the following states are alternately repeated, that are a high voltage applied state 11 at pre-drive time, a low voltage applied state 12 in a stop period (stop line), and a high voltage applied state 11 at pre-drive time.

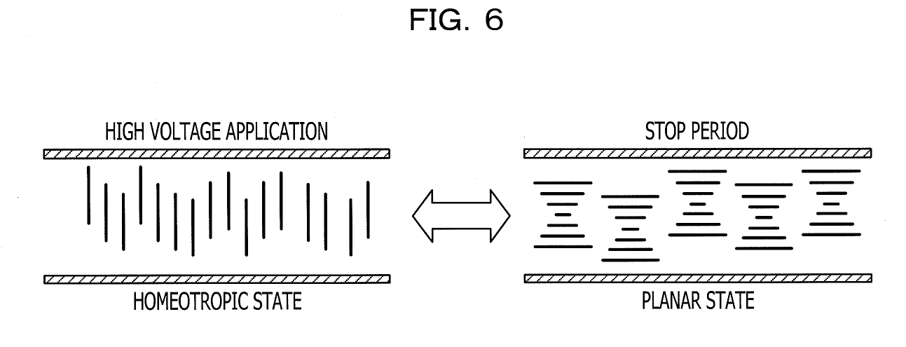

FIG. 6 illustrates states of liquid crystals at pre-drive. As illustrated in FIG. 6, when a high voltage is applied during pre-drive, the helical structure of the liquid crystal molecules is completely disentangled. Thus, the liquid crystal is brought into a homeotropic state where all the molecules follow the direction of the electric field. Meanwhile, during a stop period, continuous application of the high voltage is interrupted and a planar state is obtained. In other words, even if the cholesteric liquid crystal becomes a homeotropic state by applying a high voltage at pre-drive, a planar state is obtained by interrupting application of the high voltage during the stop period.

According to the embodiment, as illustrated in FIG. 5, by setting a stop line between the pre-drive lines, a case in which a certain pixel is included in the pre-drive line and a case in which the certain pixel is included in the stop line are repeated in a short time period. In other words, a high voltage and a low voltage are repeatedly applied to liquid crystal molecules in pixels. Hence, as described in reference to FIG. 3, response characteristics are shifted to a high-voltage side for a short time voltage application; and thereby by repeating the high voltage application, a black display (and not a white display) is more likely to be obtained. In other words, according to the embodiment, a black float for a black display may be reduced, if not prevented, even after white displays continue.

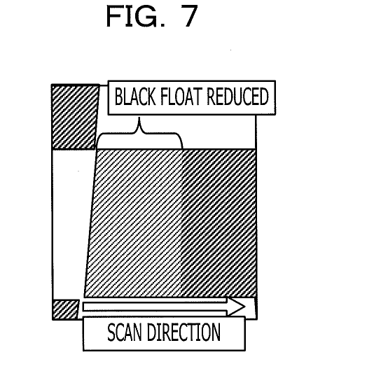

FIG. 7 illustrates a display result of a discrete pre-drive according to the embodiment. For example, a conventional black float as illustrated in FIG. 13 is reduced and the display in which almost no black float exists is obtained.

The pre-drive according to the embodiment provides a stop line between each of the pre-drive lines as illustrated in FIG. 5. However, the embodiment is not limited thereto. For example, one stop line may be provided after two pre-drive lines, or one stop line may be provided after three pre-drive lines. Furthermore, the stop line is not limited to one line, and a plurality of stop lines such as two lines and three lines may be provided.

A second embodiment will hereinafter be described. A liquid crystal driving device according to the second embodiment includes circuit configurations described by referring to FIG. 1 and FIG. 2. For example, as described above, a display element 2 is also configured with 1024×768 pixels and a cholesteric liquid crystal mixture is sealed between film substrates (electrodes). Moreover, as described above, voltages that are output from the common driver 3 and the segment driver 4 are applied to the display element 2.

The second embodiment is configured to repeat the performance of pre-drive and the non-performance of pre-drive, and configured so as to reduce an occurrence of a black float as in the first embodiment.

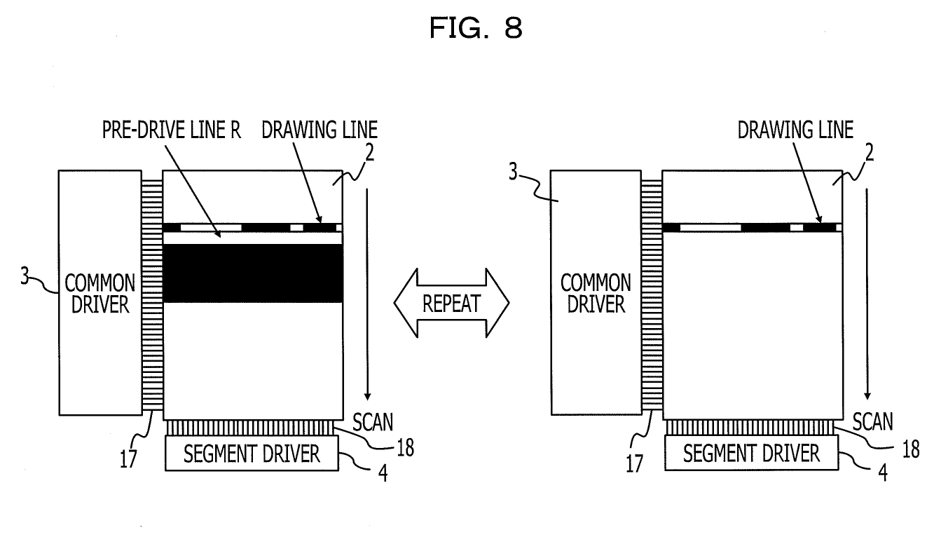

FIG. 8 is a schematic view of driving processing according to the second embodiment. As illustrated in (a) of FIG. 8, according to the embodiment, a drawing line and pre-drive lines R are substantially simultaneously driven. Subsequently, no pre-drive lines R is driven, and as illustrated in (b) of FIG. 8, typically the drawing line is driven. An occurrence of a black float is reduced, if not prevented, by repeating the processing.

In other words, when the drawing line and pre-drive lines R are simultaneously driven (at a high voltage application), a helical structure of the liquid crystal molecules is completely disentangled as in the first embodiment. Accordingly, the liquid crystal is brought into a homeotropic state where all the molecules follow the direction of the electric field. Meanwhile, continuous application of the high voltage is interrupted when no pre-drive line R is subsequently driven. Therefore, as described above, a black float for a black display may be reduced, if not prevented, even for a black display after white displays continue because high voltage is not continuously applied.

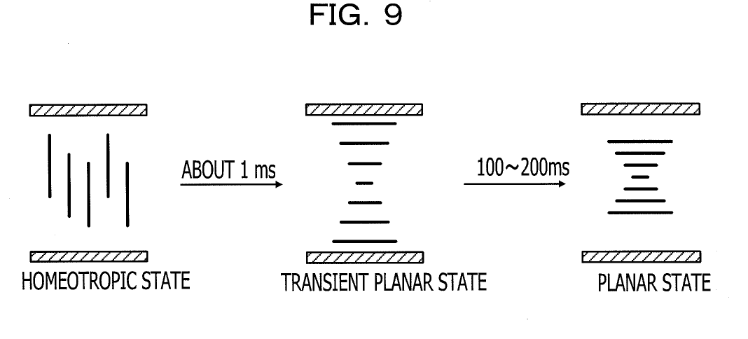

FIG. 9 illustrates changes of states from a high voltage application state during a pre-drive period to a low voltage application state during a stop period. When the liquid crystal driving device applies a low voltage to a cholesteric liquid crystal in a homeotropic state, a planar state is obtained through a state called a transient planar state. A transition time from the homeotropic state to the transient planar state is about 1 ms and after that, the state changes into the planar state after 100 ms to 200 ms.

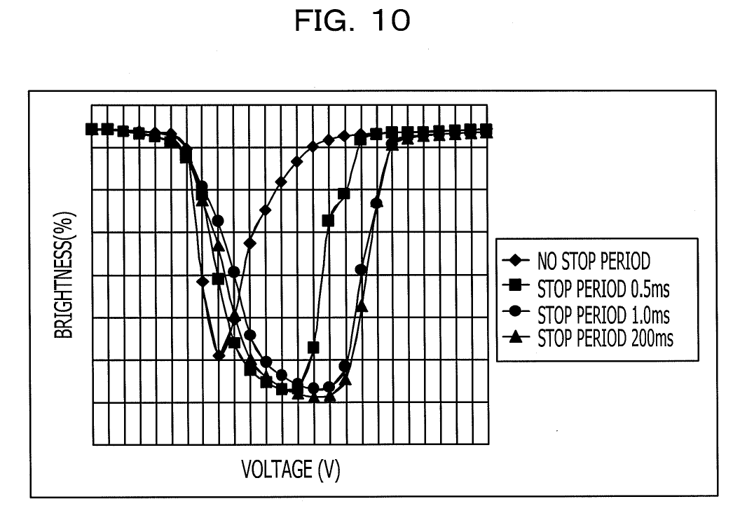

FIG. 10 illustrates a relationship between a length of the above-described stop period and brightness of the display element 2. FIG. 10 compares brightness of the display element 2 when the stop period is 0.5 ms, 1.0 ms, and 200 ms, respectively.

As illustrated in FIG. 10, substantially the same brightness for the display element 2 is obtained when a stop time is 1 ms or more and when a stop time is 200 ms. In other words, a stop period according to the embodiment may be 1 ms or more so as to obtain a transient planar state, and thereby a drawing time will not take significantly long due to the stop period.

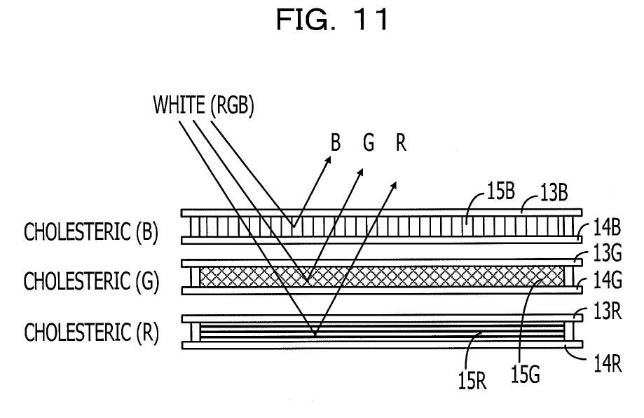

FIG. 11 is a conceptual diagram of a liquid crystal display device in which RGB of the display element 2 is laminated. Each of the display elements for blue, green, and red includes Indium Tin Oxide (ITO) electrodes 13 and 14, and a cholesteric liquid crystal 15. The cholesteric liquid crystal 15 is sealed between the ITO electrode 13 and the ITO electrode 14. Each of the display elements for blue, green, and red displays color by reflecting light with a certain cycle. In FIG. 11, ITO electrodes for blue display element is indicated as 13B, and 14B; ITO electrodes for the green display element are indicated as 13G and 14G; and ITO electrodes for the red display element are indicated as 13R and 14R. A cholestric liquid crystal for blue is indicated as 15B, that for green is indicated as 15G, and that for red is indicated as 15R.

The display device in which three layers of RGB are laminated reflects light with a certain wavelength at each layer. In other words, a preferable color display may be achieved by composite light of reflected light. For example, when each display element is controlled by 16 gradation, a liquid crystal display device may be created that achieves 4096 gradation color display.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiments in accordance with aspects of the present inventions have been described in detail, it should be understood that various changes, substitutions, and alterations could be made hereto without departing from the spirit and scope of the invention.

What is claimed is:

1. A liquid crystal driving device, comprising:
a plurality of scan electrodes;
a signal electrode arranged along a direction that intersects with the plurality of scan electrodes and forms a pixel for each intersection with the plurality of scan electrodes; and
a control circuit configured to set a drawing line that is made up of a series of the pixels, and a plurality of pre-drive lines that are different from the drawing line along a direction in parallel with the scan electrode and supplies image data that corresponds to the drawing line from the signal electrode while shifting the drawing line and the plurality of pre-drive lines to a direction that intersects with the scan electrode, wherein the control circuit discretely drives the plurality of pre-drive lines.

2. The liquid crystal driving device according to claim 1, wherein the plurality of pre-drive lines include a stop line to which a high voltage is not applied from the signal electrode.

3. The liquid crystal driving device according to claim 1, wherein the plurality of pre-drive lines repeats driving and stopping.

4. The liquid crystal driving device according to claim 2, wherein the plurality of pre-drive lines includes a stop line immediately before the drawing line.

5. The liquid crystal driving device according to claim 2, wherein a stop period of the stop line is at least a time period so that a state of a liquid crystal is transitioned from a homeotropic state to a transient planar state.

6. A liquid crystal display device, comprising:
a plurality of scan electrodes;
a signal electrode arranged along a direction that intersects with the plurality of scan electrodes and forms a pixel for each intersection with the plurality of scan electrodes; and
a control circuit configured to set a drawing line that is made up of a series of the pixels, and a plurality of pre-drive lines that are different from the drawing line along a direction in parallel with the scan electrode and supplies image data that corresponds to the drawing line from the signal electrode while shifting the drawing line and the plurality of pre-drive lines to a direction that intersects with the scan electrode, wherein the control circuit discretely drives the plurality of pre-drive lines.

7. The liquid crystal display device according to claim 6, wherein the plurality of pre-drive lines include a stop line to which a high voltage is not applied from the signal electrode.

8. The liquid crystal display device according to claim 6, wherein the plurality of pre-drive lines repeats driving and stopping.

9. The liquid crystal display device according to claim 7, wherein the plurality of pre-drive lines includes a stop line immediately before the drawing line.

10. The liquid crystal display device according to claim 7, wherein a stop period of the stop line is at least a time period so that a state of a liquid crystal is transitioned from a homeotropic state to a transient planar state.
